(19) United States
(12) Patent Application Publication
(10) Pub. No.: US 2008/0068146 A1
(43) Pub. Date: Mar. 20, 2008

(54) Red light accident warning

(76) Inventor: Jack D. Cauldwell, Dallas, TX (US)

Correspondence Address: CRUTSINGER & BOOTH, 1601 ELM STREET, SUITE 1950, DALLAS, TX, 752014744, US

(21) Appl. No.: 11/521,760

(22) Filed: Sep. 16, 2006

(51) Int. Cl. B60Q 1/00

(52) U.S. Cl. 340/435

(57) ABSTRACT

This invention comprises a warning device that is intended to assist in the prevention of automobile accidents that result from drivers moving into an intersection where another driver is already moving through the intersection. A sensor, that can detect the movement of other vehicles directly in front of the host vehicle is utilized, with a warning system that actuates if the host vehicle begins to move forward, while other vehicle traffic from another direction is concurrently moving in front of the host vehicle.

### CROSS-REFERENCE TO RELATED APPLICATIONS

None Known.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

None.

### BACKGROUND OF THE INVENTION

The utility of vehicle accident avoidance systems are well recognized. Sophisticated systems have been introduced to provide additional vehicle safety for drivers. This is exampled in U.S. Pat. No. 5,652,705 (Spiess), which involves the computation of other vehicle speeds and determinations of the best way to avoid an accident. The use of laser radars has also been shown to be effective in determining and predicting potential collisions, since they are accurate and can quickly determine relative speeds. This is shown and exampled in U.S. Pat. No. 5,314,037 (Shaw et al.).

Other methods have been introduced that involve a host vehicle in motion, as compared with other vehicles and their interaction between each other. This is exampled in U.S. Pat. No. 6,819,991 (Rao et al.). In virtually all collision threat assessment systems, safety device warning systems signal when the potential has been determined to have passed a predetermined threshold criteria.

Intersections pose some of the greatest threats to drivers, since an intersection has vehicles moving through it at different speeds and directions. It is only through the ability of the vehicles avoiding being in the same portion of the intersection at the same time as vehicles moving in other directions that typically prevents collisions.

Automobiles often enter intersections in which they either have no right-of-way, or where their right of way has recently terminated. Where electronic lighted signals are used to direct traffic, it is not uncommon for a vehicle that is intent on “running a yellow light” to race through an intersection to avoid having to stop. Persons who are moving through an intersection after the right of way has terminated for them pose a great risk to other drivers that are entering the intersection from other directions, since the paths of travel will often intersect each other. Additionally, it is not uncommon for drivers to illegally follow another driver through an intersection, where the right of way has already terminated for the first illegal driver. The second driver may assume that the first illegal driver will clear the way for the second illegal driver's passage.

Attempts to make intersections safer, by providing information to or about vehicles approaching said intersection is exampled in U.S. Pat. No. 4,928,101 (Favors), which allows for a warning system using an ultrasonic method, to be attached to a stationary corner to warn oncoming objects that are approaching the intersection. This does not provide any additional warning for vehicles that are already well aware of the intersection, and are simply awaiting their turn to enter the intersection once their right of way has been established. Further, this particular invention is not workable with all intersections that a host car will be in contact with.

It is not uncommon for drivers to enter an intersection because they see the right of way traffic signal change giving them permission to move forward. Drivers often look for a triggering reaction, as much as the signal granting right of way. For example, a driver in the front row who starts to move forward quickly, will often trigger the same reaction in adjacent drivers.

Although drivers are often urged to look both ways before entering an intersection once they have the right of way, people seldom do this if they are relying on a traffic signal to give them the right of way, or rely simply on other drivers' actions. A system is necessary that will provide such a warning for vehicles prior to entering intersections if danger conditions are present. Attempts have been made to provide warning systems for pedestrians that are approaching vehicles or where said vehicles are moving towards them. This is exampled in U.S. Pat. No. 6,784,800 (Orzechowscki), where a zone of detection exists around the perimeter or partial perimeter of the vehicle, extending outward several feet. This system, although useful for the detection of pedestrians, would not provide suitable information regarding an actual intersection for vehicle movement, since vehicle movement generally involves rapid speeds, and very little time to react to other vehicles.

### SUMMARY OF THE INVENTION

This system is intended to provide a warning to drivers that are stationary at an intersection, and are the first vehicles in line that are preparing to enter the intersection. This is a “host” vehicle. And has the warning system implemented.

This system is intended to provide the host vehicle with a warning or information that allows the host driver to be aware that traffic is continuing to move through an intersection adverse to the host vehicle direction of future travel, regardless of whether or not the host vehicle has the right-of-way.

This invention requires no new equipment at any intersection and is totally reliant on the electronics installed in the drivers vehicle. The system also does not require every vehicle to be equipped, before it is detected by other vehicles.

Vehicles that are equipped with this invention are able to detect vehicles that are not equipped.

This invention operates in a manner that allows a driver of a host vehicle to be made aware that traffic has moved through an intersection at a point where the other traffic is intersecting the projected direction of travel for the host vehicle. The apparatus itself comprises a motion type detector means that is able to determine whether or not objects are moving, or have moved, through its field of view. The field of view is optimally directly in front of the host vehicle.

In one variation, the motion type detector has its comprehensible field of view directly in front of the vehicle it is attached to, and is a fairly narrow beam. The system is only intended to be used when the speed of the host vehicle, relative to the road on which it travels, drops below a set speed or is at a complete stop. Once the host vehicle is either not moving, or has dropped to a threshold speed, the motion detection system will activate and register an alarm if a vehicle passes in front of the motion sensor. If no vehicles pass in front of the motion detector, then no alarm is registered.

This apparatus and method is intended to be used on vehicles that are situated at the front of their line of traffic and are waiting to enter an intersection. Accordingly, this invention is used on a host vehicle that is immediately adjacent to the intersection, and is the first vehicle in their lane to enter the intersection once their right-of-way has been established. Vehicles that are not first in line can generally rely on the vehicles ahead of them to provide information that the right of way had not only transferred to them, but is safe to proceed.

The apparatus is activated when the host vehicle has ceased forward momentum for a predetermined amount of time. Once the apparatus is actuated, the movement of an object through its field of view will be able to be quickly determined. The field of view may only comprises a few degrees, and only comprise a narrow field of view directly in front of the vehicle. Other sensor systems that are commonly known and understood may also be used, such as magnetic field interruption sensors, as well as any motion detection device, where the zone of detection is directly in front of the host vehicle.

This warning system is not intended to provide information on the motion of vehicles that are beginning to enter the intersection from another direction, and are not in front of the host vehicle. Rather, this apparatus and method simply provides host vehicle drivers with the information that other vehicles have been or are continuing to move through the intersection.

The warning system may comprise a simple light and or sound activated warning, that conveys to the driver that vehicles are moving, or have moved, through the intersection, and that caution should be used before entering into the intersection. While this system may notify the driver during the time they are stopped and waiting their turn, it becomes a secondary warning system, to allow the driver to not only rely solely on the change of the traffic signal.

This warning becomes more important, in situations where vehicles are continuing to move through an intersection when their right-of-way has terminated. Vehicles will often follow another vehicle in front of them, if both are trying to make it through an intersection where the right of way has just recently terminated. A driver that is initially entering an intersection, and is relying solely on the fact that the traffic signal has provided them with a right-of-way, may be significantly at risk of collision from other drivers that are racing through the intersection trying to “beat” the light, and entering the intersection after the direction lights have changed. It is not uncommon for several vehicles to attempt to see if they can make it through the intersection, even though the right of way has terminated. This warning system detects vehicle movement through an intersection, and allows the driver to be aware that this is ongoing, and makes the driver of the host vehicle more aware of recent traffic activity, and thus will provide the impetus to make them more cautious.

Once the system is activated, any movement detected that meets of exceeds a certain threshold of detection, an alarm is activated. The alarm may remain on, such as a light or sound, or may be intermittent, or as the host desires.

The alarm remains on until the host begins to move forward, and after reaching a certain distance or time of movement, the alarm deactivates.

### DETAILED DESCRIPTION OF THE INVENTION

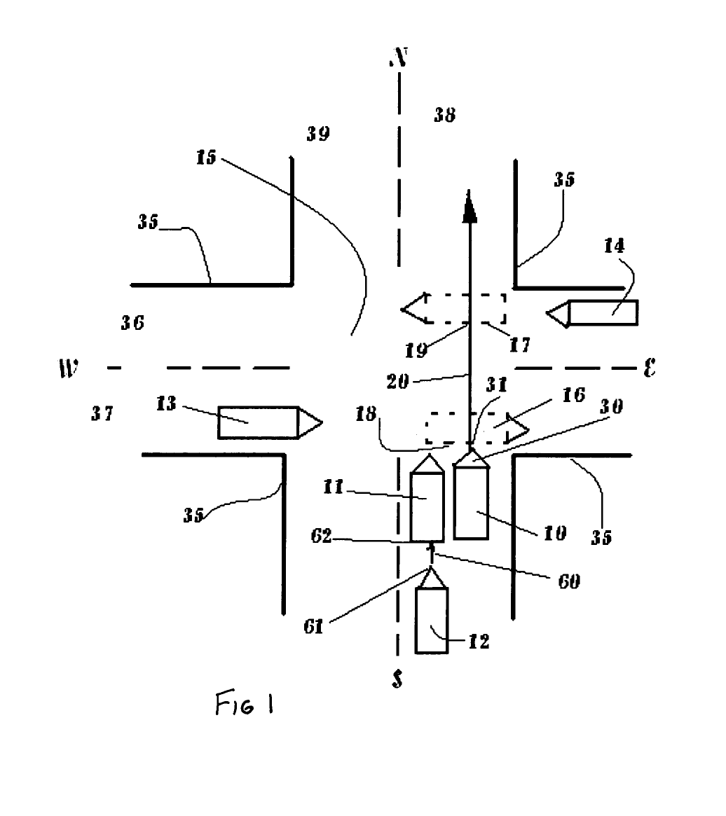

Referring now to FIG. 1, an aerial view of an intersection is shown. The intersection is comprised of a central common area 15, through which vehicles from multiple directions will travel through at various times. The common area 15 is defined by the area where a westbound lane 36, eastbound lane 37, northbound lane 38 and southbound lane 39 overlap one another. For purposes of explaining this invention, an intersection having four directions of travel will be used. The perimeter of the common area 15 is generally defined by the curb 35 or other marking that sets the limit of each of the lanes 36 through 39. It should be understood that the term “intersection” is not limited to an overlap of any specific type or number of lanes or directions. Clearly, some intersections may have fewer or more lanes, or fewer or more directions of travel at various degrees relative to one another. The intersection described here is but one of many conceivable intersection possibilities, and this description is not intended to limit the scope of what an intersection is through the defining of various number and direction of intersecting lanes.

The host vehicle 10 is shown, with its direction of travel indicated by the triangular projection 30 on the front portion of the host vehicle 10. As indicated by the projection 30, the host vehicle is pointing North. Immediately next to the host vehicle 10 is an adjacent vehicle 11, which is also indicating a direction of travel parallel to the host vehicle 10, being North, through use of the triangular projection indicating not only the front of the adjacent vehicle 11 but also the direction of travel. Host vehicle 10 and adjacent vehicle 11 are shown in the position (front line) they would typically occupy if they were stopped at a point immediately prior to entering the intersection and awaiting their turn to proceed through the intersection common area 15. Either the host vehicle 10 or the adjacent vehicle 11 may have parallel directions of future travel, or either vehicle 10 and 11 may intend to move in different directions. For example, the host vehicle 10 may intend to proceed through the common area 15 in a Northern direction, or it may intend to turn right so that it will be in the Eastbound lane 37 after its turn. Any other allowable directions and options available may also apply.

Likewise, the adjacent vehicle 11 may intend on moving forward in the Northbound lane 38, turn right to move into the Eastbound lane 37, or turn left to move into the Westbound lane 36. In either of the above described options of movement for vehicles 10 and 11, some type of encroachment into the common area 15 will be necessary. Alternatively, where there are right turn lanes and acceleration lanes after the turn, so that a vehicle turning right does not technically enter into a common area 15 within the intersection, any vehicle that has turned will likely be subject to being in close proximity to traffic that has moved through the common area 15.

A second row vehicle 12 is shown situated immediately behind the adjacent vehicle 11, with its direction of travel likewise indicated by the triangular projection on the front of said vehicle 12. Vehicles 10, 11 and 12 are all assumed to be stopped and awaiting their turn to enter into the common area 15 of the intersection, or at the very least, be concerned about movement of other vehicles through the common area 15 of the intersection.

Also indicated in FIG. 1, are oncoming vehicles 13 and 14, which represent oncoming vehicles that are beginning to move through the common area 15 of the intersection, in a manner that is perpendicular to the intended future direction of travel for vehicles 10, 11 and 12.

Oncoming vehicle 13 is moving from left to right in front of vehicles 10 and 11, with its direction of travel comprising movement from the West to the East. Oncoming vehicle 14 is moving from the East to the West.

Oncoming vehicle 13 is shown entering the intersection, with its future projected, or anticipated, position 16 indicated directly in front of host vehicle 10.

For purposes of this example, vehicle 13 will move to position 16. Further, for purposes of giving an example of movement, vehicle 14 will move from the East to the West to position 17, as both vehicles proceed through the common area 15 of the intersection.

Host vehicle 10 is provided with a sensor means 31 on the front portion of its structure, which is able to sense movement of other objects through its field of view 20. As is shown in FIG. 1, the sensor means field of view 20 comprises a narrow beam, commensurate with a laser motion detector apparatus, or any other narrow beam focusing system that detects movement through its field of view 20.

Oncoming vehicle 13 is not detectable using the narrow beam field of view 20, until it reaches approximately projected position 16, which is directly in front of vehicle 10. Once the oncoming vehicle 13 has reached projected position 16, which is within the scope of the field of view 20, the sensor means 31 will detect the movement of vehicle 13 when it has reached projected position 16 at distance 18, which would comprise the distance from the sensor means 31 to the vehicle 16, so that the sensor means detects movement of the right side of oncoming vehicle 13 closest to detection means 31.

Oncoming vehicle 14 is shown as moving from right to left, or East to West in front of host vehicle 10, and is shown initially in its position as it is approaching the intersection common area 15. The eventual or projected position of approaching vehicle 14 is exemplified as projected position 17, when the oncoming vehicle 14 has moved directly in front of host vehicle 10, and has moved through the detection field of view 20, so that when the oncoming vehicle 14 has reached projected position 17, it will be detectable by the motion sensor means 31 at distance 19, which would comprise the detection point of the left side of the oncoming vehicle 14 as it moves through field of view 20.

Also shown in FIG. 1, is a motion detection means 31 as shown on second row vehicle 12, that is immediately behind another vehicle 11, in FIG. 1. The field of view 60 projects outward from sensor means 61, and detects the vehicle, being the adjacent vehicle 11, at position/distance 62. Since there is no appreciable lateral movement between vehicles 12 and 11, or 12 and 10, the threshold of the motion sensor means 61 is not reached, and will not alert its driver.

The vehicles on the second row, such as shown as vehicle 12, have an additional warning to the oncoming traffic, being the difference in time that they can actually enter the intersection common area 15, as compared with the host vehicle 10, as well as the fact that vehicles in front, such as the host vehicle 10 will actually enter the intersection common area 15 first, and will itself be subject to automobiles that are moving th rough the intersection when the right of way has expired. Vehicles alarms on second and subsequent rows are not activated, since the vehicles in front of them block their motion sensors. It is assumed that red light accidents happen to vehicles in the front row, because they are the first to enter the intersection when the right of way changes.

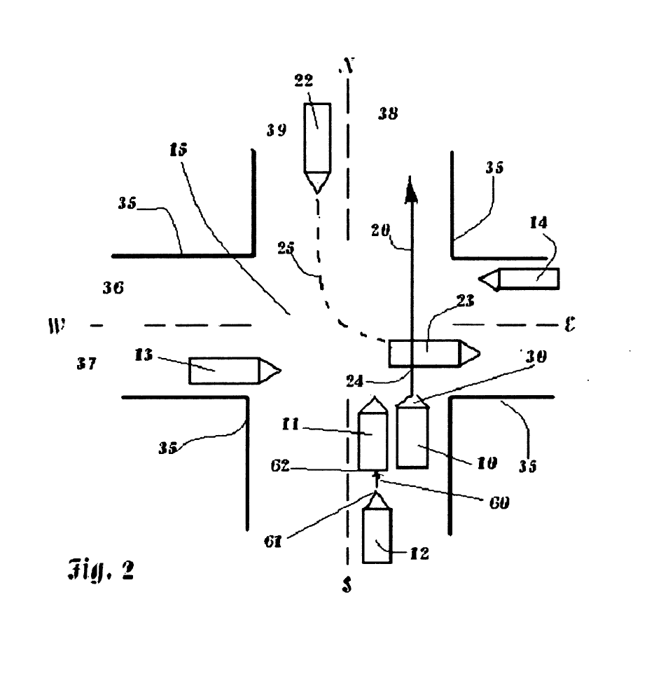

Referring now also to FIG. 2, the same intersection having a common area 15 as shown in FIG. 1, is depicted in FIG. 2. Host vehicle 10, adjacent vehicle 11 and second row vehicle 12 are all shown waiting to enter the intersection common area 15. Also shown in FIG. 2, is approaching vehicle 22, which has a projected path of travel 25 so that approaching vehicle 22 will reach projected position 23. This typifies an approaching vehicle 22 that is making a left-hand turn against oncoming traffic. Many intersections, especially those with heavy traffic load, specifically allow left-hand turns prior to allowing other traffic from moving straight through an intersection. It is not uncommon for approaching vehicles that are intending to make a left-hand turn to try and make it through the intersection common area 15 even after their right of way has terminated and they are legally supposed to yield to approaching vehicles such as vehicles 10, 11 and 12. The field of view 20, emitted from sensor means 31 on host vehicle 10, allows detection of approaching vehicle 22 when it is approximately at position 23, with the detection position/distance determined to be at point 24. The determination of the movement through the field of view 20 will cause the audible and/or visible alarm to activate so that it is discernable by the driver of the host vehicle 10. This will advise the driver to remain cautious when starting to move forward, since the impact of the alarm is to remind the driver that traffic has been moving through the intersection. It is the lateral movement of vehicle 22, in relation to vehicle 10 that meets the threshold of the motion sensor means 31. If vehicle 22 turned right, or proceeded straight through the common area 15 on Southbound lane 39, said vehicle 22 would not cross in front of vehicle 10, and provide no threat as to possible collision. The sensor means 31 is intended to provide a warning that vehicles are crossing in front of the host vehicle 10, and that those vehicles and others that may follow pose a threat as to collision with vehicle 10 if vehicle 10 moves into the common area 15.

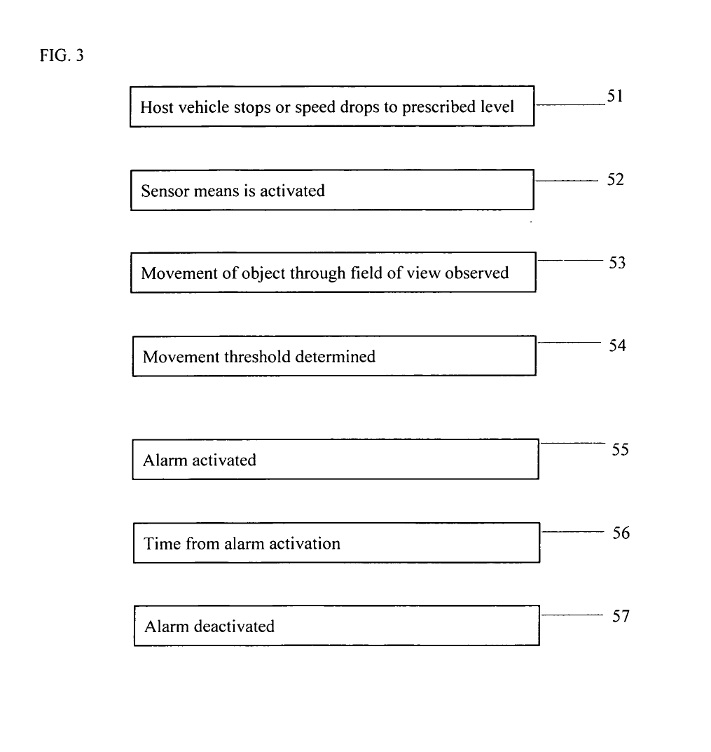

Referring now to FIG. 3, the alarm operation is shown. When the host vehicle 10 has its relative speed to the road drop below prescribed level, a sensor means to determine vehicle speed will alert the alarm apparatus to activate 52. The relative speed in step 51 may be set at a very low rate of movement, or may also be set so that the vehicle speed must be equal to a complete stop. This is to ensure that the sensor means 31 is only active when the vehicle is at an intersection, prior to entering into the common area.

Once the vehicle has dropped to the threshold or prescribed level of speed 51, sensor means 31 is activated. This allows the sensor means 31 to only be operational when the vehicle is stopped at an intersection, but before it enters into the common area 15. Once activated, the sensor means observes and determines movement of objects through its field of view 53. Any movement must reach a previously determined threshold, which is able to be set according to the system sensitivity and ability of the sensor means 31, to detect movement of other vehicles. Once a movement threshold is determined 54, a signal is sent to activate an alarm. Lateral movement is the type of movement that the sensor means 31 is set to determine. Sufficient lateral movement through the field of view 20, indicates that other traffic is moving through the common area 15, and that it is not safe to enter the intersection. When the alarm is activated 55, the driver of the host vehicle 10 will be advised that traffic appears to be moving through the intersection common area 15. The alarm remains active for a specific period of time from the last alarm activation 55, to account for possible vehicles that are in the process of entering the intersection common area 15, which have not yet moved into or through the field of view 20 of the sensor means 31. After a sufficient passage of time, that has been predetermined for optimal operation and warning, the alarm is deactivated 57. The passage of time may comprise less than one second, to several seconds in time delay. The alarm itself comprises any type of audible or visible signal, that supplies the operator of the host vehicle 10 that traffic is ongoing through the intersection in front of the host vehicle 10. This will provide information in addition to the available traffic signals.

It should be understood that the warning, given by this system, to the driver, should be limited to the location of the vehicle 10 prior to moving into the intersection are 15. The warning is only to alert the driver that other vehicles are continuing to move through the intersection, and not as to the number of vehicles moving in front of the host vehicle 10. Only one vehicle moving across the field of view of the vehicle is necessary to activate the alarm. The alarm will remain in an activated state, until the driver of the vehicle, in this case the host vehicle 10 moves forward into the intersection.

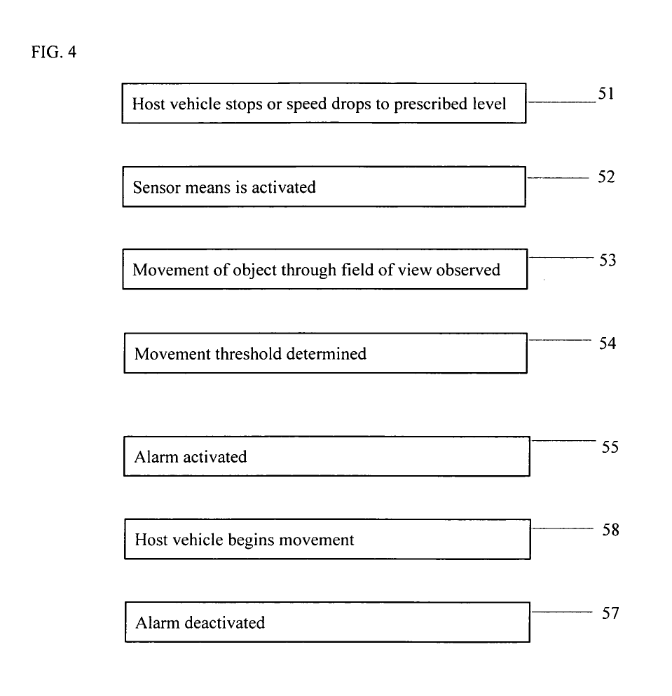

Referring now also to FIG. 4, the operational steps are identical as those in FIG. 3, with the modification of the alarm remaining activated, until the host vehicle 10 begins to move 58. Once the operational step where the host vehicle begins to move 58 occurs, this in itself will cause the alarm to deactivate 57.

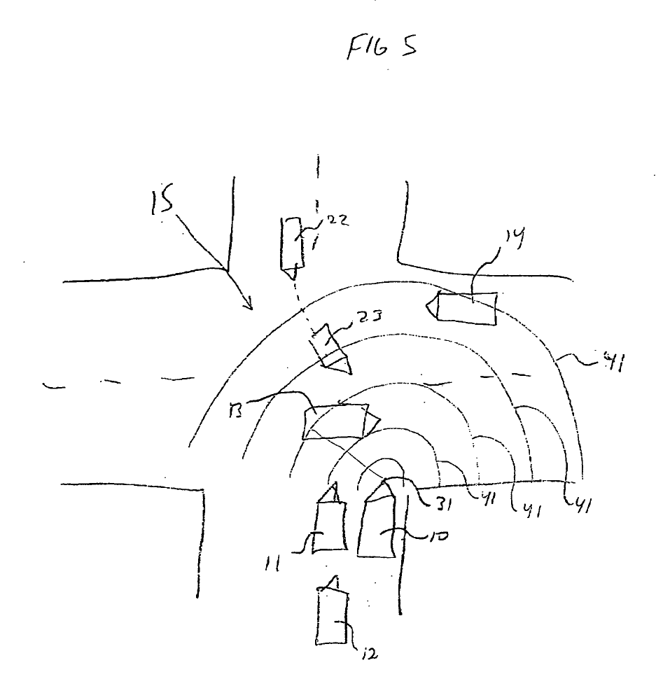

As is also shown in FIG. 5, the intersection common area 15 is shown, with host vehicle 10, and vehicles shown as vehicles 12, 13, 14 shown in their approximate positions as they were in FIG. 1 and FIG. 2. Also added is vehicle 22, which is shown as moving to vehicle position 23, where vehicle 22 is making a left hand turn in front of vehicle 10, where vehicle 22 is an oncoming vehicle in relation to vehicle 10. The sensor means 31 is shown with a field of view that is unrestricted to the single line of sight and direction as shown in the field of view 20 depicted in FIG. 1 and FIG. 2. In this FIG. 5, a magnetic type field sensor means is used, with field lines 41 depicting the area of detection, which occupies virtually 180 degrees forward of the vehicle. Therefore, lateral movement of vehicle 13 in front of vehicle 10 is detectable, along with vehicles 14 and 23. The intent of the motion detector is to warn the driver of the host vehicle if any vehicle crosses his projected path. This will alert the driver when he proceeds into the intersection—making him more cautious and hopefully avoid a red light accident.

From the foregoing statements, summary, and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim:

1. A warning device that cautions host vehicles to enter an intersection common area with care, due to the presence of other vehicles that have been detected as moving through the intersection common area in front of the host vehicle, prior to the host vehicle entering the intersection common area, comprising:
a. a detection means, that is able to determine movement of vehicles within a detection area, where said detection means is mounted on the front portion of a vehicle, and which defines a detection area forward of the host vehicle;
b. an alarm means that alerts the host vehicle of detected movement of other vehicles through the detection area.

2. A warning device, as recited in claim 1, in which the detection means comprises a magnetic field sensor which is able to detect movement of metal mass that affect magnetic fields, when said metal masses move through the detection area.

3. A warning device, as recited in claim 1, in which the detection means comprises a sonar emitter, which emits a sonar pulse into the detection area, and which is able to detect movement of objects capable of reflecting a sonar pulse, as moving through the detection area.

4. A warning device, as recited in claim 1, in which the detection means comprises a doppler type wave emitter/detector, which uses changes in wavelength to detect movement of objects through the detection area.

5. A warning device, as recited in claim 1, in which the detection means comprises a laser emitter/detector, which uses light waves to detect movement of objects through the detection area.

6. A warning device, as recited in claim 1, in which the alarm means comprises a warning light that is actuated when any movement of another vehicle is detected within the detection area, and said warning light remains activated until the host vehicle begins to move forward into the intersection common area.

7. A warning device, as recited in claim 1, in which the alarm means comprises a warning light that is actuated when any movement of another vehicle is detected within the detection area, and said warning light remains activated for a desired period of time after the host vehicle begins forward movement.

8. A warning device, as recited in claim 1, in which the alarm means comprises an audible alarm that is actuated when any movement of another vehicle is detected within the detection area, and said audible alarm remains activated until the host vehicle begins to move forward into the intersection common area.

9. A warning device, as recited in claim 1, in which the alarm means comprises an audible alarm that is actuated when any movement of another vehicle is detected within the detection area, and said audible alarm remains activated for a desired period of time after the host vehicle begins forward movement.

10. A warning device, as recited in claim 1, in which the alarm means comprises an audible alarm that is activated when after movement of another vehicle is detected within the detection area, with said audible alarm activating only after the host vehicle begins forward movement.
